(19) United States
(12) Patent Application Publication
(10) Pub. No.: US 2013/0254511 A1
(43) Pub. Date: Sep. 26, 2013

(54) Improving Storage Lifetime Using Data Swapping

(71) Applicants: Saugata Das Purkayastha, Bangalore (IN); Vijaya Kumar Kilari, Kasturi Nagar (IN)

(72) Inventors: Saugata Das Purkayastha, Bangalore (IN); Vijaya Kumar Kilari, Kasturi Nagar (IN)

(73) Assignee: ST-Ericsson SA, Plan-les-Ouates (CH)

(21) Appl. No.: 13/879,127

(22) PCT Filed: Oct. 24, 2011
(86) PCT No.: PCT/EP2011/068568

§ 371 Date: May 21, 2013

(30) Foreign Application Priority Data
Oct. 22, 2010 (IN) 2531/DEL/2010

(51) Int. Cl. G06F 3/06; G06F 12/02

(52) U.S. Cl. CPC G06F 3/0616; G06F 12/023
USPC 711/170

(57) ABSTRACT

A memory management system for managing memory of a processing system having a primary memory and at least one secondary memory is disclosed. The memory is managed by optimizing the number of writes required by swapping one or more relevant pages of an application from the primary memory to the at least one secondary memory. The system comprises of a dynamic memory manager for allocating memory to the application from a memory pool and having a first table containing virtual addresses and chunk sizes of memory allocated by the application. The system further comprises of a swap manager having a second table containing the physical addresses of the primary memory pages and information whether the pages are allocated or not. The system further comprises of a memory management unit having a third table containing a mapping information of the physical addresses and the virtual addresses of the one or more physical pages used by the application and information whether the page is dirty or not.

### FIELD OF THE INVENTION

The invention generally relates to storage devices and more particularly to a method for improving memory lifetime using data swapping.

### BACKGROUND OF THE INVENTION

A storage device specifically random-access memory (RAM) is one of the costly components of embedded devices. Hence, efficient management of memory and saving storage space in the RAM is an important requirement for the embedded devices. There are different techniques to save the storage space in RAM. On demand swapping of code and data is one amongst the known techniques to save the storage space in RAM. With demand swapping of code and data, only part of the code and data is stored in the RAM. The complete code and data is stored in a secondary memory of the embedded devices. NAND, NOR, eMMC, eSD, SSD, UFS or their variants are most common secondary memory used in the embedded devices. A conventional method of demand swapping is illustrated in FIG. 1 and FIG. 2. As illustrated in FIG. 1, only a part of the code or data say a first part 1 is shadowed or swapped in RAM and the other part of the code or data say second part 2 are kept at secondary memory. As illustrated in FIG. 2, the first part 1 is swapped out and the second part 2 is shadowed or swapped in. When the data is swapped out the code being read only, need not be saved back in the secondary memory

Both the secondary memory and the RAM are split into pages. Typically, the complete code and data stored in the secondary memory is called virtual space and the virtual space is split into virtual pages. The pages stored in the RAM are called physical pages. A memory management unit (MMU) of the processor maintains a mapping table containing information of the virtual page and the physical page. The mapping table is known as MMU table. The system starts with minimum number of code and data pages in RAM. As and when, application accesses a page, which is not there in RAM; the processor raises a page fault exception. A swap manager, which is also known as a page fault exception handler, or a paging manager, swaps in the required page from the secondary memory. During the process of swapping in, the swap manager may swap out an old data page from the RAM to create space for the swap-in page. The swapped out old data pages are required to be saved in the secondary memory so that the modified data pages can be read as and when required.

All the memory devices have a lifetime on number of times it can be written. Considering a single level cell (SLC) NAND with backup memory of 2 blocks (128 pages), virtual space of 1 page, SLC NAND lifetime of 100000 program/erase cycles and a page fault occurs every 1 second then it could trigger a write to NAND every 1 second. If we distribute the writes across two blocks then this would mean that the NAND lifetime is 148 days. This will not be acceptable for any embedded device.

According to one known solution of the above stated problem, additional space is reserved in the secondary memory to increase lifetime of the memory device. For example, in the above NAND example, if four blocks are used then the lifetime of NAND becomes 296 days; if eight blocks are used then lifetime of NAND becomes 592 days. However, the disadvantage of this solution is that it reduces the available memory capacity for user.

According to another known solution, the processor has additional capability to mark a page as dirty, if the page is modified. Then, during swapping out a page, the swap manager checks the MMU table and writes only the data pages, which are dirty to secondary memory. This reduces the number of pages, which are written to secondary memory, and improves lifetime. However, the MMU capability of the processor to identify the dirty page is expensive. Popular ARM cores like ARM7/ARM9's MMU do not have capability to mark the dirty pages. Also the dirty pages marked in the processor MMU table do not necessarily mean that the page is used by an application.

According to yet another known solution of the problem, all the physical pages, which are present in RAM, are marked read only in the MMU table. When a page fault occurs then the swap manager checks whether the access requested is write and the page is marked read only. Then, such pages are marked as dirty and read-only permission from the MMU table is removed. When swapping out pages, the swap manager writes only the dirty data pages to the secondary memory. The disadvantage of this solution is that there will be page faults raised for the non-dirty pages even when page is present in the RAM. Also the dirty pages identified in this method do not necessarily mean that the page is used by an application. This adds overhead in the overall performance of the embedded system.

Hence, there is a well-felt need for a system and method for effectively reducing the number of writes while swapping in or out data from memory.

The subject matter disclosed herein is not limited to embodiments that solve any disadvantages or that operate only in environments such as those described above. Rather, this background is only provided to illustrate one exemplary technology area where some embodiments described herein may be practiced.

### SUMMARY OF THE INVENTION

A memory management system for managing memory of a processing system having a primary memory and a secondary memory unit is disclosed. The system can also have more secondary memory units than one. The memory is managed by reducing the number of writes required by swapping one or more relevant pages of an application from the primary memory to the at least one secondary memory. The system comprises a dynamic memory manager for allocating memory to an application from a memory pool. The dynamic memory manager has a first table containing virtual addresses of allocated memory and sizes of each chunk of allocated memory. The system also comprises a swap manager having a second table containing physical addresses of pages of the primary memory and an indication of whether these pages are allocated to an application. The swap manager is configured to read and compare primary memory pages with corresponding pages in the secondary memory to determine a change in the primary memory pages, and to update the corresponding secondary memory in case a change is determined. The second table contains the physical addresses of the one or more physical pages in primary memory used by the application and contains information on whether the physical page is allocated or not. In some embodiments, the system further comprises a memory management unit having a third table containing a mapping information of the physical addresses and the virtual addresses of the one or more physical pages used by the application and in some embodiments also information about whether a specific page is dirty or modified.

A method of controlling memory in a processing system is disclosed. The processing system comprises a primary memory and a secondary memory. The method comprises allocating memory to an application from a memory pool, based on a first table containing virtual addresses of allocated memory and sizes of each chunk of allocated memory; and reading and comparing primary memory pages with corresponding pages in the secondary memory to determine a change in the primary memory pages, and updating the corresponding secondary memory in case a change is determined, based on a second table containing physical addresses of pages of the primary memory and an indication of whether these pages are allocated to an application. In some embodiments, the method further comprises of swapping the relevant pages from the primary memory to the secondary memory and discarding non-relevant pages thereby improving memory lifetime by reducing the number of writes required by swapping one or more relevant pages from primary memory to the secondary memory.

### BRIEF DESCRIPTION OF THE DRAWINGS

The features of the present invention will become better understood when the following description is read with reference to the accompanying drawings, wherein

FIG. 1 illustrates a known method of On-demand swapping of code and data;

FIG. 2 illustrates another known method of On-demand swapping of code and data;

FIG. 3 illustrates a schematic diagram of a memory management system in accordance with an embodiment of the invention;

FIG. 4 illustrates a flowchart showing a method of swapping of relevant pages in accordance with an embodiment of the invention.

FIG. 5 illustrates swap management during memory allocation/free according to an exemplary embodiment of the invention;

FIG. 6 illustrates a swap management during memory allocation/free according to the exemplary embodiment of the invention;

FIG. 7 illustrates an implementation of a swap manager and a dynamic memory manager according to the exemplary embodiment of the invention;

FIG. 8 is a flow chart to illustrate the process of removing data from the memory according to the exemplary embodiment of the invention;

FIG. 9 is a flow chart to illustrate the process of memory allocation according to the exemplary embodiment of the invention; and

FIG. 10 is a flowchart for handling dynamic memory notification according to the exemplary embodiment of the invention.

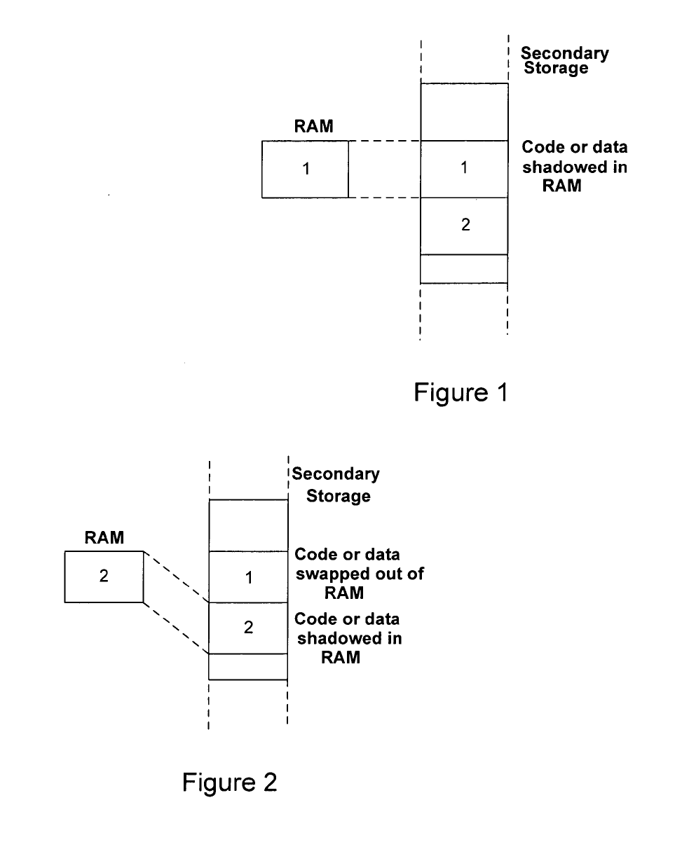

### DESCRIPTION OF THE INVENTION

A method of optimizing memory in a processing system is disclosed. According to an aspect, the memory is managed by swapping one or more relevant pages from a primary memory to a secondary memory and discarding the non-relevant pages thereby improving storage lifetime by reducing the number of writes required by swapping one or more relevant pages from primary memory to the secondary memory. According to an embodiment the primary memory corresponds to RAM.

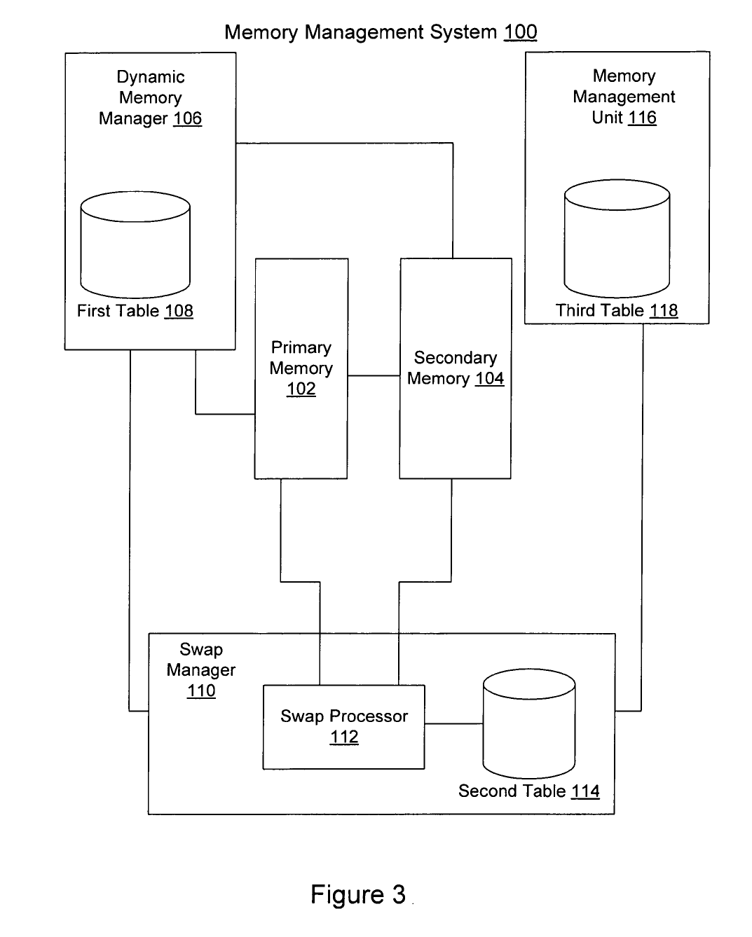

FIG. 3 illustrates a memory management system 100 in accordance with an embodiment of the invention. The memory management system 100 is configured for managing memory of a processing system (not shown) having a primary memory 102 and at least one secondary memory 104. According to an embodiment, the memory management system 100 improves the memory lifetime by reducing the number of writes to secondary memory 104.

The memory management system 100 may comprise of a dynamic memory manager 106, a swap manager 110 and a memory management unit 116.

The dynamic memory manager 106 is configured for allocating memory to an application from a memory pool trying to access one or more physical pages. The dynamic memory manager 106 may comprise of a first table 108 containing virtual addresses and size of each memory chunks currently used by the application.

The swap manager 110 may comprise of a second table 114 containing the physical addresses of the physical pages in primary memory and the information whether the page is allocated. The swap manager 110 may further comprise of a swap processor 112 configured to swap data between the primary memory 102 and the secondary memory 104.

The memory management unit 116 may comprise of a third table 118 containing a mapping information of the physical addresses and the virtual addresses of the one or more virtual pages used by the application. The table 118 may also store information such as whether the page is dirty or modified by any application.

According to an embodiment, the swap manager 110 is further configured to update information from the dynamic memory manager 106.

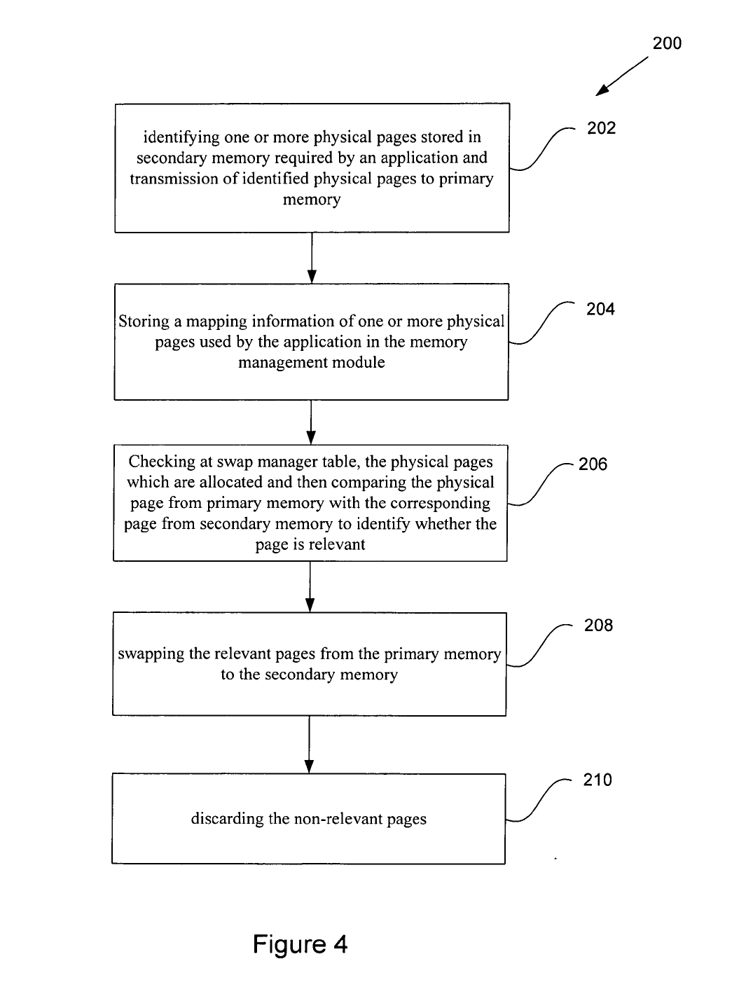

FIG. 4 is a flowchart illustrating a method of swapping of relevant pages in accordance with an embodiment of the invention. The method comprises of identifying one or more physical pages stored in the secondary memory 104 required by an application and transmitting the identified physical pages to the primary memory 102 for the application to use the physical pages in the primary memory 102, as disclosed in step 202. Further, storing a mapping information of one or more physical pages used by the application in the memory management unit 116, as per step 204. Further, at the primary memory 102, the originally identified physical pages are checked at the swap manager table 114 to determine whether the identified pages are allocated pages or non-allocated pages, as disclosed in step 206. According to an exemplary example, the physical pages may be allocated and modified by the application accessing the physical pages; the modified part of the physical pages may have to be updated in the secondary memory 104, thereby making the physical pages that require updating as relevant pages. On the other hand, the physical pages which are not allocated or allocated but not modified by the application, and do not need any updating in the secondary memory 104, may be classified as non-relevant pages. Further, the relevant pages are swapped from the primary memory 102 to the secondary memory 104 and the non-relevant pages are discarded from the primary memory 102, as disclosed in step 208 and 210.

According to an embodiment, the relevant pages are the pages that are allocated by the application in the primary memory 102. The system 100 is further configured to update the same physical page in the secondary memory 104 or store a fresh copy of the updated physical page in the secondary memory 104 thereby deleting the old existing copy of the physical page. As the physical pages are transferred out to the secondary memory 104, the memory space in the primary memory 102 is freed up.

According to yet another embodiment, the step of identifying allocated modified pages 206 includes using the memory management unit table 118 or reading the pages from secondary memory 104 and comparing with that stored in primary memory 102.

According to yet another an embodiment, the step of swapping 208 includes transferring only the allocated modified pages to the secondary memory 104 and updating the memory management table 118.

According to yet another an embodiment, the step of swapping 208 also includes recording modifications in the secondary memory 104 made by the application while accessing the physical page in the primary memory 102.

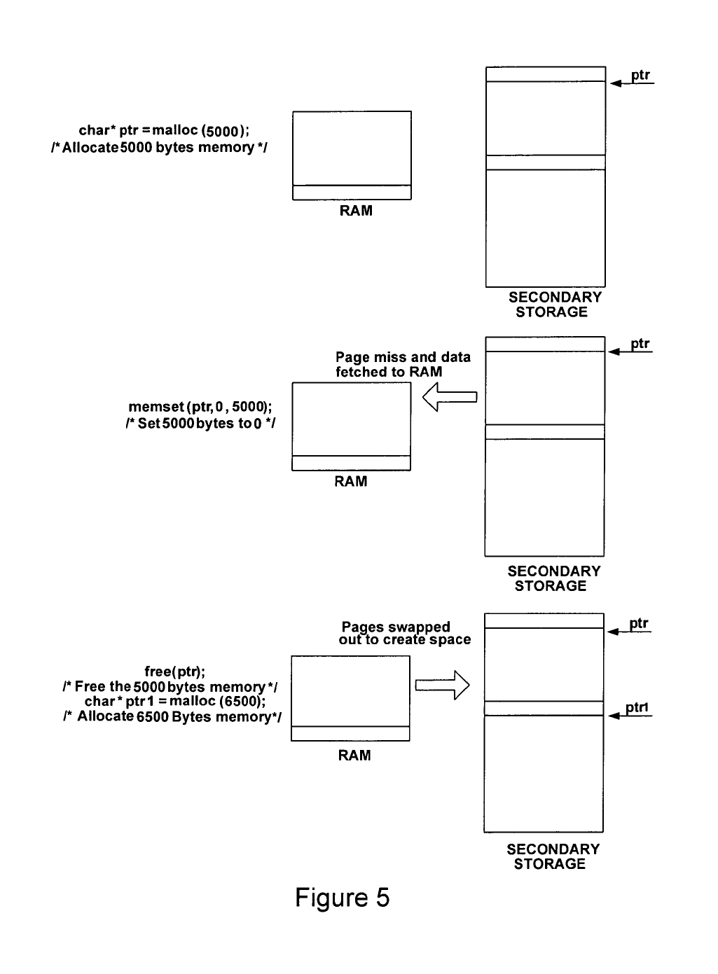

FIG. 5 to FIG. 10 illustrates exemplary embodiments of a swap management technique for memory allocation or memory freeing in accordance with a specific example of the invention.

FIG. 5 illustrates a swap management technique during memory allocation/freeing according to an exemplary embodiment of the invention. According to this exemplary embodiment, the method tries to identify the allocated memory, which is required to be saved with the help of the dynamic memory manager. Then using the memory management unit 116, only the dirty allocated pages are saved in secondary memory 104.

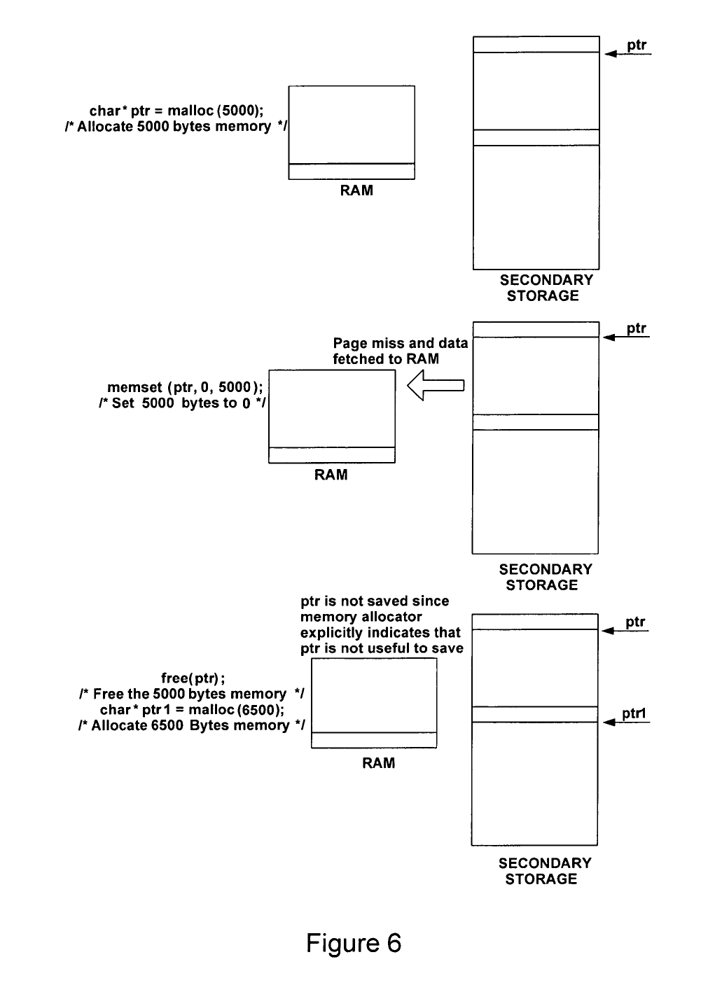

FIG. 6 illustrates the swap management technique during memory allocation/freeing according to the exemplary embodiment of the invention. As illustrated, when a buffer belonging to “ptr” is saved in the secondary memory 104, it is not required anymore by the application accessing the buffer. Further, the swap manager 110 identifies with the help of dynamic memory manager 106 the buffers that are not required to be saved. If it identifies such buffers then it does not save them in secondary memory 104 while swapping out the pages from the primary memory 102 to the secondary memory 104. This reduces the number of pages written to secondary memory 104 and improves its lifetime.

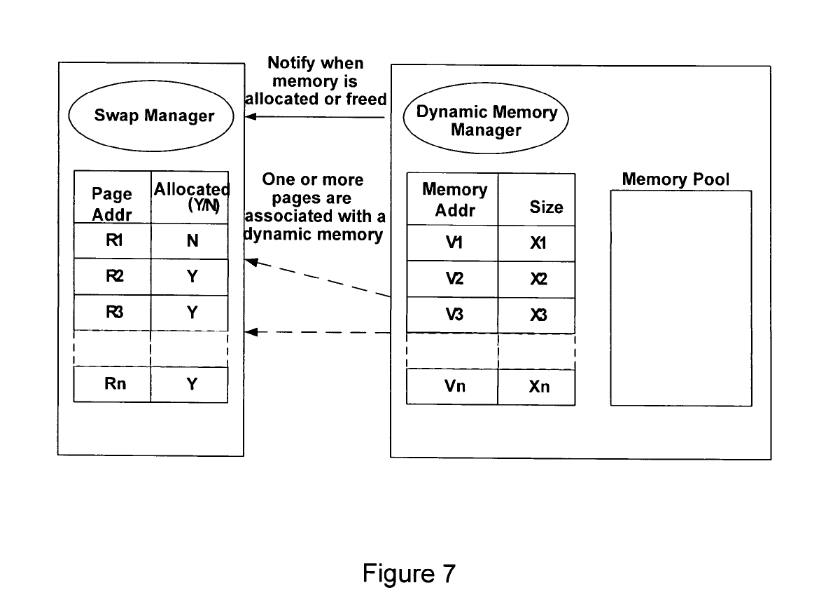

FIG. 7 illustrates the implementation of dynamic memory manager 106 and swap manager 110 according to the exemplary embodiment of the invention. The Dynamic memory manager 106 is responsible for providing dynamic memory to application from a memory pool and maintains a first table 108 for each memory chunk, which is allocated or free together with the size of the each memory chunk. The memory address managed by the dynamic memory manager 106, {V1, V2, V3 . . . Vn} are the virtual address. Some of the physical pages of an allocated memory could be in the RAM. The mapping between the virtual address {V1, V2, V3 . . . Vn} and the physical RAM address {R1, R2, R3 . . . Rn} is managed by the memory management unit 116. The memory management unit 116 may reside in a processor (not shown) of the memory management system 100. As illustrated above, the RAM is classified as a primary memory 102.

The Swap manager 110 maintains a second table 114 for every physical page addresses, which is currently in the RAM, and whether the page is allocated or not. According to this embodiment, a page may be classified as a allocated physical page if it is still allocated by the application accessing the physical page. If the memory page is dirty then the swap manager 110 writes the memory page from the RAM (primary memory 102) to the secondary memory 104 when swapping the page out. Each virtual address chunk, {{V1, V1+X1}, {V2, V2+X2}, {V3, V3+X3} . . . {Vn, Vn+Xn}}, may contain one or more physical pages completely within it. For example, in FIG. 5, the virtual address {V3, V3+X3} contains the physical pages R2 and R3.

It is to be noted that the virtual address may not start at a physical page boundary. It also may not be of multiple page size. For the virtual address {virtual_addr, virtual_addr+chunk_size}, the physical pages {start_addr, number_of_page} which are completely within the virtual address chunk can be found with a procedure such as find_page_and_address as defined by Pseudo code for finding start page and size as illustrated below.

```
function find_page_and_address (virtual_addr, chunk_size)
  end_addr = virtual_addr + chunk_size;
  If (virtual_addr % PAGE_SIZE != 0) then
    start_addr = (virtual_addr / PAGE_SIZE) + PAGE_SIZE;
  else
    start_addr = virtual_addr;
  If (end_addr > start_addr) then
    number_of_page = (end_addr - start_addr) / PAGE_SIZE;
  else
    number_of_page = 0;
    start_addr = 0;
  return {start_addr, number_of_page};
```

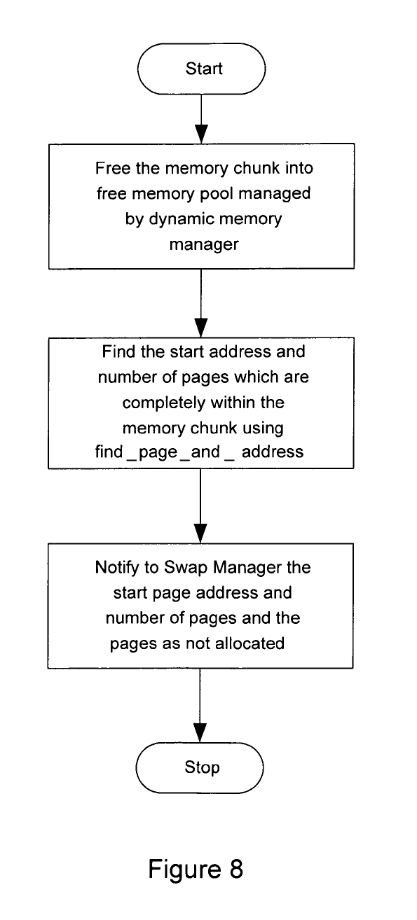

FIG. 8 illustrates a flow chart of dynamic memory manager 106 freeing the memory in accordance with the exemplary embodiment of the invention. As illustrated, the dynamic memory manager 106 notifies the swap manager 110 when memory is allocated or freed. As illustrated, the dynamic memory manager 106 may follow following steps to free the memory:

a. Freeing the memory chunk into free memory pool managed by dynamic memory manager 106;

b. Find the start address and number of pages which are completely within the memory chunk using find_page_and_address; and

c. Notifying the swap manager 110 the start page address and number of pages and the pages as non-allocated.

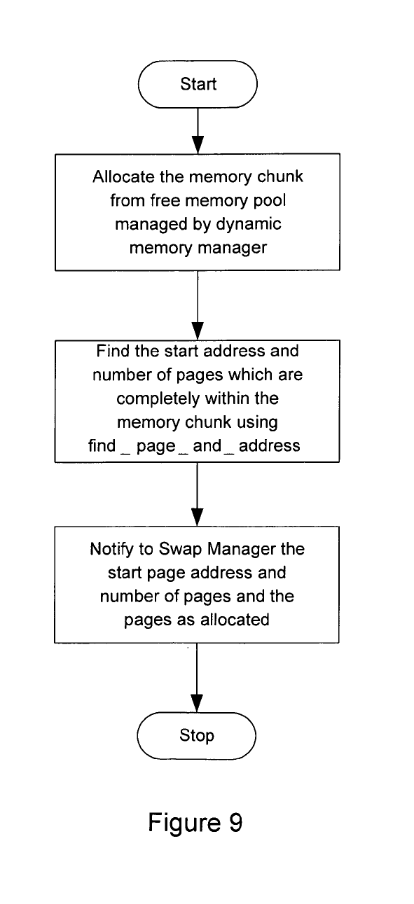

FIG. 9 illustrates a flow chart of the dynamic memory manager 106 allocating the memory in accordance with the exemplary embodiment of the invention. As illustrated, the dynamic memory manager 106 allocates the memory by the steps of:

a. Allocating the memory chunk from free memory pool managed by dynamic memory manager 106;

b. Finding the start address and number of pages which are completely within the memory chunk using find_page_and_address; and

c. Notifying the swap manager 110 the start page address and number of pages and the pages as allocated.

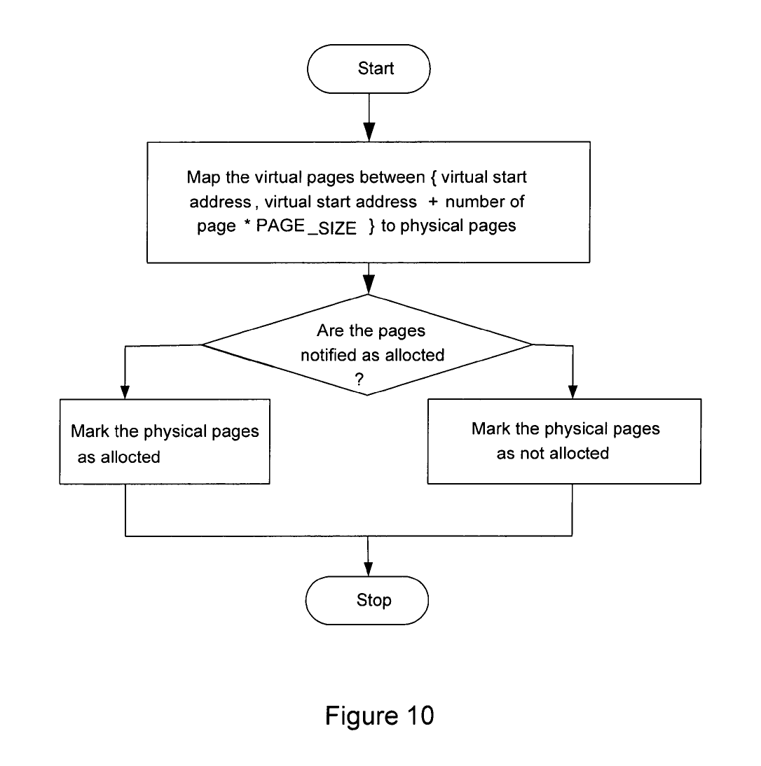

FIG. 10 illustrates a flowchart for handling of the dynamic memory notification by the swap manager 110 in accordance with the exemplary embodiment of the invention. As illustrated, the swap manager 110 marks all the data pages when it is first swapped in the RAM (primary memory 102) as allocated. The swap manager 110 marks all the code pages when it is swapped in the RAM as non-allocated. When the dynamic memory manager 106 notifies the swap manager 110 the virtual pages, which are allocated or freed, the swap manager 110 identifies the corresponding physical pages. This is done with the help of the memory management unit 116. The swap manager 110 then marks all the physical pages as allocated or non-allocated depending on whether the memory was allocated or freed. When swapping out pages from RAM to the secondary memory 104, the swap manager 110 identifies the modified allocated pages utilizing memory management unit table 118 or by reading and comparing the page. The swap manager 110 only writes in modified allocated pages to secondary memory 104.

It is an advantage of the invention that physical pages which are not required, to be saved in a secondary memory are identified, whereby the technique drops the number of write to the secondary memory. This also helps in both improving the secondary memory lifetime and reducing the physical page miss treatment time for data.

While specific language has been used to describe the invention, any limitations arising on account of the same are not intended. As would be apparent to a person in the art, various working modifications may be made to the method in order to implement the inventive concept as taught herein.

We claim:

1. A memory management system for managing memory of a processing system having a primary memory unit and a secondary memory unit, by controlling a number of writes to the secondary memory, the system comprising:
a dynamic memory manager for allocating memory to an application from a memory pool, having a first table containing virtual addresses of allocated memory and sizes of each chunk of allocated memory,
a swap manager having a second table containing physical addresses of pages of the primary memory and an indication of whether these pages are allocated to an application, wherein the swap manager is configured to read and compare primary memory pages with corresponding pages in the secondary memory to determine a change in the primary memory pages, and to update the corresponding secondary memory in case a change is determined

2. A memory management system as claimed in claim 1 wherein the dynamic memory manager is configured to pass an allocation information and a free memory notification to the swap manager.

3. A memory management system as claimed in claim 1, wherein the swap manager, based allocation information and a free memory notification received from the dynamic memory manager, identifies physical pages in the primary memory as allocated or free.

4. A memory management system as claimed in claim 1, wherein the swap manager compares the content of an allocated page from primary memory with the corresponding page in secondary memory to identify whether the allocated page has been modified.

5. A memory management system as claimed in claim 4, wherein the swap manager stores in the secondary memory the modified allocated pages from the primary memory during swapping.

6. A memory management system as claimed in claim 4, wherein the swap manager discards unallocated physical pages from saving in secondary memory during swapping.

7. A memory management system as claimed in claim 4, wherein the swap manager discards allocated but unmodified physical pages from saving in secondary memory during swapping.

8. A method for managing memory of a processing system having a primary memory and a secondary memory, by controlling a number of writes to the secondary memory, the method comprising:
allocating memory to an application from a memory pool, based on a first table containing virtual addresses of allocated memory and sizes of each chunk of allocated memory,
reading and comparing primary memory pages with corresponding pages in the secondary memory to determine a change in the primary memory pages, and updating the corresponding secondary memory in case a change is determined, based on a second table containing physical addresses of pages of the primary memory and an indication of whether these pages are allocated to an application,
